(19) United States
(12) Patent Application Publication
(10) Pub. No.: US 2011/0179888 A1
(43) Pub. Date: Jul. 28, 2011

(54) UNDISTURBED SOIL AND SEDIMENT SAMPLING

(76) Inventor: Bijan Danesh, St. Catharines (CA)

(21) Appl. No.: 12/695,675

(22) Filed: Jan. 28, 2010

(51) Int. Cl. G01N 1/08

(52) U.S. Cl. 73/864.44

(57) ABSTRACT

Device, system and method for sampling of soft sediments with retention of sample material and profile. A barge is anchored and stabilized in position; sampling tubes are driven through underlying sediments using continuous and controllable translational pneumatic force; a torpedo-shaped end piece leads the sampling tubes into the sediments. Once at desired depth, a rotational force is applied to sampling tubes. Fins located around torpedo prevent the torpedo from rotating and connection between leading sampling tube and torpedo is tightened. O-ring located between torpedo and leading sampling tube is squeezed as a result of such tightening and bulges inward pinching the core inside sampling tube. During retrieval, core is more likely to break at the location of the pinch which has introduced structural discontinuity; core above the pinch is capped by compacted material at the pinch. O-ring does not disturb sample integrity during descent. Winch and pulley mechanism may assist.

### BACKGROUND OF THE INVENTION

1. Field of the Invention

The present invention pertains generally to the field of environmental sampling and, more particularly, to sampling of soft soils or sediments.

2. Description of Related Art

Industrial, agricultural, recreational, and waste disposal activities introduce hazardous contaminants into air, water, and soil. These contaminants pose immediate hazards or are capable of posing future hazards to man and the ecosystem. Contaminants become hazardous when they exceed certain permissible background levels, predetermined to be protective of human health and ecological health. When the permissible background concentrations are exceeded, site cleanup is required. Site clean up, or remediation, involves the removal, reduction, immobilization or neutralization of contaminants. This, in effect, reduces the adverse impact of the contaminants on human health and safety and the environment. Remediation is a multi-stage process which includes characterization, delineation, planning, and execution of remediation. Characterization is identification of the various contaminants at the site. Delineation is defining the extent of the contamination. Planning is identifying the various options available for remediation, selecting a method, and budgeting. Finally, execution of remediation is implementing the plan using the selected methods for clean up.

The phases of characterization and delineation require sampling. Moreover, sampling is conducted throughout and at the conclusion of remediation to evaluate the effectiveness of the remediation.

As with air and unsaturated soil, in an aquatic environment, environmental sampling and reliability of sample integrity is an important issue for characterization and delineation of contaminated sites. Further, during a remediation project, sediment samples are collected for confirmatory analysis to establish the level of cleanup of a contaminated site.

Sediments are mineral and organic materials that are formed beneath an aqueous layer and may still be located under water. Although sedimentation is a natural process, aquatic systems are often negatively affected by human activity from various processes that include mining, agriculture, forestry practices, and road construction. Excessive aquatic sedimentation from human disturbances alters community composition and decreases survival, population size, and reproductive success of fishes, amphibians, and benthic invertebrates that depend on the aquatic system. Therefore, sediments are one of the most common and geographically widespread pollutants of water systems. Sediments function as a sink as well as a potential source for toxic and conventional pollutants. Even if the discharge of pollutants is completely eliminated, contaminated sediments in a body of water can operate as a continuing source of pollution to aquatic life and the populations using the water body as their drinking water supply.

Sampling and analysis of sediments underlying a body of water forms the first step toward characterization of contamination and assists remediation of the contaminated areas. Analysis of sediments may be biological, chemical, or physical in nature and may be used to determine one or more of the following: toxicity, biological availability and effects of contaminants, benthic biota, types of contaminants, extent and magnitude of contamination, contaminant migration pathways and source, fate of contaminants, and grain size distribution. Before analysis is possible proper samples must be collected.

There are significant problems associated with sediment sample collection. Certain factors are important and intrinsic in achieving the specific objectives in sampling and, if overlooked, can adversely affect the informational value of the samples. These include sample representativeness, sample integrity, collecting a sufficient number of samples, applying appropriate sampling techniques, and sample preservation prior to analysis.

Choice of a proper sampler is key in obtaining useful samples. Sediment samples that are obtained by using an appropriate sampler provide more and better information. The choice of a sampler is usually based on a number of factors such as the hoisting equipment required, the physical constraints of sampling at the particular location, penetration depth of the sampler, possibility for sample recovery, the desired sample integrity, sampler material, and the required sample volume. These factors are further elaborated below.

The type of hoisting equipment required may be a significant constraint in terms of the type of vessel used, the experience of the field team in operating hoisting equipment and the resulting costs. The physical constraints that can limit the use of a sampler include depth of the water and the material to be samples, currents, waves and sediment characteristics. The penetration depth of some samplers, for example those obtained through vibro-corers or drilling, can be controlled while, in others, depth is determined by the nature of sediments and degree of sediment consolidation. The sample recovery rate is determined by the quantity of materials present in the sampler. If the sampler is full, the recovery rate is 100%. Poor recovery indicates sampler malfunction, losses during recovery, or simply that the sampler is not adapted to the type of sediments found. Sample integrity is an important aspect to be taken into account, particularly in the case of poor recovery. If the sampler is not completely closed, the fine fractions may be subject to washout when the sampler is being retrieved. Washout of fine fractions introduces a bias in the sample. The material of which the sampler is manufactured must also be considered to avoid any possibility of sample contamination. Sediments collected for an analysis of metals should not come into contact with metal materials, for example. Similarly, sediments taken for an analysis of organic substances should not come into contact with any plastics. However, samplers that have a Teflon® lining or are made of stainless steel are generally considered appropriate for most types of samples. Adequate quality control and sub-sampling techniques will also minimize contamination risks. The required sample volume depends on the type and number of analyses. The choice of sampler should also be based on the objectives of the study, such as surface sampling or dredging depth or both, and the information available on the nature of the sediments to be removed. If sediment types vary, it may be necessary to use more than one type of sampler.

The two main types of samplers frequently used for sediment characterization studies are grab samplers and core samplers.

Grab Samplers

Grab samples are collected at the sediment surface and represent the depth of sediment penetrated by the sampler. A grab sampler is any type of device that collects a disturbed sample at the sediment-water interface. A “disturbed” sample is one that has lost its vertical and lateral integrity and can't be subdivided into meaningful layers or fractions. Grab samplers are useful for surface sampling, when the properties of sediments are homogeneous owing to a high accumulation rate, reworking by currents, ships, and the likes, or if recurrent maintenance dredging is to be carried out.

Some common types of grab samplers include hand-held samplers, dragline samplers, small dredge samplers, and clamshell dredge bucket.

Shovels, trowels, and buckets can be used to collect sediment samples by hand in shallow streams. Moreover, sediment sampling in deeper waters by divers using hand-held samplers is becoming a fairly common practice. Hand-held grab samplers are inexpensive, require little or no supporting equipment, can control sample penetration to a limited extent, and generally have good recovery.

Dragline samplers are operated by being dragged along the bottom. These types of samplers include bottom dredgers equipped with nets for collecting biological materials. For example, a pipe dredge is a metal tube, about 6″ in diameter and 18″ long, which is used to collect surface samples from hard, rocky surfaces.

There are a number of small, lightweight dredge samplers available from commercial sources. Most small dredge samplers will only penetrate 1-3 inches in sandy sediments. The same sampler might penetrate 6-12 inches in fine-grained sediments that are soft and unconsolidated. Sediments that have a hard, consolidated surface often give poor recovery and may be subject to sample bias. Soft sediments will often yield 100% recovery with grab samplers.

Commercial clamshell dredges, generally having 0.5-3 cubic yard buckets, can also be used for collecting sediment samples. However, these devices are not designed for sampling. Clamshell buckets are operated by a crane and require a sizable floating plant. The bucket is typically lowered onto the deck of the floating plant and sample(s) removed with shovels or trowels. A crane operated clamshell bucket can penetrate several feet, even into compacted sand. Recovery is usually good. Sample bias can be avoided by compositing several subsamples from different areas within the bucket grab. Multi-purpose sediment sampling may require large sample volumes and the clamshell dredge bucket will provide a far larger sample volume than is necessary for sediment contaminant testing.

Core Samplers

A core sampler is a device that extracts a vertical cylinder of sediments of some length. The core sample may or may not fully retain its integrity. Some types of core samplers are designed to assure the least loss of vertical integrity. For others, some loss of integrity is acceptable. Core sampling equipment that may be used includes equipment designed for geotechnical exploration and well construction. In addition, there are several pieces of equipment developed specifically for sampling bottom sediments. Generally, corers are used when samples are to be taken of the entire depth to be dredged. Sometimes sampling is done to a depth below the planned dredging depth; this is done to characterize sediments that will be exposed if dredging depth is greater than expected and to ensure that sediments with contaminant concentrations above those of overlying materials are not exposed by the dredging.

The core samplers include hand-held samplers, gravity core samplers, box core samplers, vibra-core, split-spoon samplers and piston samplers.

Hand-held core samplers are available from commercial sources. Many laboratories and contractors have fabricated core-sampling equipment from lengths of pipe. For some applications, this type of improvised sampler is quite acceptable. The pipe material used should be selected to avoid sample contamination. The hand-held core sampler is pushed into the sediments to the desired depth and is subsequently withdrawn. The sediments are pushed out with a rod, or the pipe or tube is cut to expose the sample for removal. Hand-held samplers can be used by wading in shallow streams or by divers. Because it is generally necessary that the operator stand to drive and withdraw the sampler, hand-held samplers should not be operated from a boat. Rather, vessels with a flat deck, such as a small barge, pontoon boat or floating plant are needed to safely support the sampler. The operation of a hand-held core sampler is limited by the depth of water, sediment characteristics, and sediment thickness. For total depths (water+sediment) of greater than 10-15 feet, the required length of the sampler becomes unmanageable for hand operation. Hand-held cores can be easily pushed through soft sediments, but are not recommended for consolidated materials. The bias of a core sample is related to its recovery and recovery with hand-held core samplers is variable. A sample with poor recovery may have preferentially lost sediment from the leading (deeper) end. A catcher is typically used at the front end of the core to hold the sediments in place as the sampler is withdrawn. Samplers with an open end can also be “capped” by driving them through the soft sediments and a few inches into hard clay or sand. Moreover, hand-held cores may loose some vertical integrity, as sediments may be compressed in the core. A 3-foot drive may yield only 2 feet of sample, even with good recovery. Consequently, while hand-held cores are acceptable for vertically composited samples, vertical subdivision may not reflect the true elevation of sub-samples.

Gravity core samples are deployed on a cable and penetrate the bottom sediments with only the force of gravity. Most corers have small diameters (1-2″) with variable lengths, and come are equipped with additional weights and a catcher. Some have vanes or stabilizing fins. Small gravity corers can be operated from small and medium sized boats by hand or with a winch. Best performance is found where the corer is allowed to freefall between 2-3 meters. Gravity corers can collect up to 2 meters of soft sediments, and are not suitable for hard or consolidated sediments. Sample recovery and vertical integrity are variable. Box corers are gravity corers designed for collecting large rectangular sediment cores of the upper 50 cm sediment layer. Small box corers, weighing about 30 pounds, are equipped with additional weights (up to 100 pounds) to improve penetration. Much larger box corers, up to 2 m×2 m and weighing up to 800 Kg, have been fabricated. The corer is lowered to the bottom by a cable with little freefall, and then triggered with a messenger. Small box corers may be operated from a boat with a winch.

The vibracore is a long continuous tube that is driven into the sediment using a vibrating action, typically of a pneumatic impactor. The entire core is withdrawn, at which point the entire sample can be extruded and subdivided, or the tube may be cut into segments for later sample extraction. Vibracores are typically 2-4 inches in diameter. Sample lengths up to 20 feet have been successfully removed from sites in the Great Lakes tributaries. The vibracore is only suitable for unconsolidated sediments, particularly sandy sediments. They cannot penetrate most consolidated or coarse materials. Cores can be equipped with a catcher or the tube is driven into a layer of compacted material, which forms a “cap” at the bottom. The vertical integrity of vibracore samples may be disturbed and the vibration of the tube has been known to consolidate the sample. Vibracores are well suited for the collection of samples to be vertically composited.

The split-spoon sampler is the basic equipment for geotechnical exploration of unconsolidated soils. The sampler is a metal cylinder which is divided in half, lengthwise. The two halves of the spoon are held together by small pieces of threaded pipe at each end. An open cap, with a catcher is screwed on the tip. The sampler is attached to lengths of steel rod and driven into the sediments with a hammer or weight. After the sampler is withdrawn, the front and rear end pieces are unscrewed, the sampler is opened, and the sample is removed. Split-spoon samplers can be used for most types of sediments, including consolidated sand and clay. Recovery is variable, sometimes poorer, with soft fine-grained sediments. Split-spoon samplers are typically 2-3 inches in diameter, and available in lengths from 2-5 feet. Successive vertical samples can be taken by driving casing (typically a 5-inch pipe) and cleaning out the drill hole between samples.

Piston samplers use a thin metal tube that is extended forward under hydraulic force. Piston samplers can be operated from a variety of drill rigs on small floating plants. The sampler, with tube retracted, is attached to a steel rod and pushed into the sediments to the desired starting depth. At the desired starting depth, the hydraulic force is applied, generally using a water pump, and the tube is extended. When the assembly is withdrawn, the sediments in the tube are held in a partial vacuum. Finally, the tube is removed and the sediments are extracted. Piston samplers are suitable for soft, unconsolidated sediments. Recovery with soft, fine-grained sediments is excellent. The sampler can penetrate some consolidated fine-grained sediments, but not coarse materials. Sampler tubes are typically 3-4 inches in diameter and 3 feet long. The vertical integrity of individual samples is variable, but a vertically composited sample can be obtained between two elevations with accuracy, and without the need for casing.

### SUMMARY OF THE INVENTION

A detailed literature review of the current sampling techniques and core sampling equipment demonstrates substantial inefficiencies and difficulties that cause inaccuracies in the sampling results and drive up the cost of sampling. The mechanisms that drive the existing samplers are driven by manual force, by gravity, rotary force or by vibration. There are many disadvantages associated with the available samplers, such as limitations with required force to drive the sampler to desired depths, disturbing of the sampling profile due to vibration, difficulties associated with retaining the sample in the sampling device, errors associated with drift of the sampler during deployment, the time consuming nature of collecting a reliable and credible sample, and the excessive cost associated with inefficiencies of the existing samplers.

Aspects of the present invention provide systems, devices, and methods that address some of the issues identified with the prior art methods of sampling.

Aspects of the present invention further present systems, devices, and methods that can be used to collect substantially undisturbed samples of soils and sediments and can be launched from a barge or a vehicle to collect substantially undisturbed samples from land or underwater sediments in lakes, rivers and reservoirs.

Based on the review of the available technologies, some of the constraints and problems associated with the use of corers in sediment sampling are identified as follows. (1) The loss of the surface layer of sediments at the moment of penetration due to poor draining of the water inside the corer or increased pressure on the cutting head, particularly during a high-speed freefall. (2) The resuspension of surface sediments inside the sample due to the use of a piston or by shocks transmitted to the sampler. (3) Reduction in core length due to internal friction or the use of a corer of insufficient diameter for the sediment type or penetration depth desired. (4) Repeated penetration of the corer due to the drifting of the vessel or strong suction of sediments during recovery. (5) The contamination of the lower horizons due to internal washout of material from the bottom of the core during recovery due to the lack of a core retention system, excessive ascent speed or malfunction of the top valve.

Aspects of the present invention provide for un-impeded water flow by having a core sampler of sufficient diameter and by lowering the sampler in a controlled and measured manner. As such, a freefall and a bow wave that result in disturbing the top sediments are avoided.

Aspects of the present invention reduce the resuspension of surface sediments inside the sample that is caused by shocks transmitted to the sampler.

Aspects of the present invention address the drifting of the vessel or strong suction of sediments during recovery by stabilizing the barge prior to sampling. Some aspects of the present invention provide stability for the sampling barge by anchoring and immobilizing the barge using spuds, mooring anchors, a ballast that is filled with water or any combination of such methods.

Aspects of the present invention utilize a novel core retention system that reduces or prevents the washout of material from the bottom of the core and thus the contamination of the lower horizons. Introducing slight compressive force near the mouth of the corer holds the sample in place and reduces resuspension and loss of sample by effectively cutting the sample from the remaining soil or sediment below. This manner of core retention maintains the integrity of the core above the pinched perimeter and is superior to conventional core catchers that scratch, disturb and mix the sample all the way down while the sampling tube is being inserted.

Some aspects utilize a pneumatic cylinder, having straight translational up and down movement, for retrieving or sinking the corer. As such, they provide precision in sampling depth by exerting finely tunable control over the rate of penetration and retrieval of the sampler. Further, the use of pneumatic power removes the shear force by the corer on the core by eliminating the rotary motion and does not cause the disturbance that results due to vibration or pounding of the sampler.

Finally, the speed of recovery and ascent is under fine control by using the pneumatic device of the aspects of the present invention.

In Canada, United States and most of Europe, there are guidelines for sediment sampling. The guideline on sampling and analytical methods for use at contaminated sites in Ontario, Ministry of the Environment 1997 (the Regulatory Guideline) specifies several methods of sediment and soil sampling including those described above in the Background section. There is no pneumatic sampling instrumentation specified in this guideline. Further, while some vibracore systems use pneumatic impactors, the prior art does not use pneumatic force for continuous driving of the coring tubes.

Aspects of the present invention utilize pneumatic force for driving a core sampler into the desired depth of sediment and soil for substantially undisturbed sampling. Pneumatic devices use air instead of hydraulic fluid that has the potential to be a source of environmental and additional contamination.

Due to sampling technique variability, the Regulatory Guideline recommends between three and five replicate samples from each station. The Regulatory Guideline also recognizes that sampling can add significantly to the cost of a study, or alternatively, may lead to a reduction in the number of stations/locations sampled. In cases where remedial action may be considered for a contaminated site, or where severe contamination is expected, a larger number of replicate samples should be considered in order to more clearly and accurately define the nature of the contamination.

Aspects of the present invention provide samples of higher quality and integrity and therefore reduce the number of replicate samples necessary to obtain reliable results. Without the methods and systems provided by the aspects of the present invention, the large number of replicate samples required is cost prohibitive for some sites.

Aspects of the present invention provide a device for sampling soils and sediments. The device includes a cylinder having a threaded portion toward one end and leading to a penetrating nozzle toward an opposite end, and one or more fins located around and protruding outward from an external surface of the cylinder in a manner not to interfere with a downward movement of the cylinder through the soils or sediments. The threaded portion is adapted to be connected to a sampling tube, and the cylinder is adapted for receiving an O-ring that is situated to receive a compressive force responsive to a tightening of the threaded portion to the sampling tube.

The fins may protrude perpendicularly outward from the external surface of the cylinder or may form an angle different from 90 degrees with the external surface of the cylinder. The fins may extend along all of a length of the cylinder or may extend partially along the cylinder. The O-ring may be received inside the cylinder below the threaded portion or above the threaded portion away from the penetrating nozzle. The device may be made from stainless steel. The fins may be welded onto the cylinder or cast manufactured integrally with the cylinder.

Aspects of the present invention provide a system for collecting samples from a formation. The system includes one or more sampling tubes adapted to be connected together lengthwise, a torpedo ending in a penetrating nozzle and having a threaded portion adapted for connecting to a sampling tube from among the sampling tubes, the torpedo having one or more fins along an outer circumference located not to interfere with penetration of the torpedo in the formation but resisting a rotation of the torpedo once within the formation, an O-ring located between the torpedo and the sampling tube and adapted to bulge inward toward a center of the torpedo responsive to a tightening of the torpedo to the sampling tube, and a driving mechanism for driving and retrieving the sampling tubes and the torpedo into and from the formation.

The driving mechanism drives the sampling tubes by an up and down translational motion. The fins protrude perpendicularly from an outer surface of the torpedo, and the torpedo is tightened to the sampling tube by a rotational motion of the sampling tube. The driving mechanism may be selected from pneumatic, pulley and winch or a combination of the two. The system may further include a frame for holding the driving mechanism, and a vehicle for holding the frame and transporting the frame to a sampling location. When the vehicle is a barge it would be substantially stabilized by filling a ballast with water or by sinking spuds into the soils or sediments, or by a combination of both.

Aspects of the present invention provide a method for collecting cores from a formation by lowering an initial sampling tube within the formation, the initial sampling tube being led by a torpedo tip connected to the initial sampling tube, attaching additional sampling tubes as required to reach a desired sampling depth, compressing sampled core, inside the initial sampling tube, near an interface between the initial sampling tube and the torpedo tip, once at the desired sampling depth, and retrieving the sampling tubes and collecting the sampled core after the compressing of the sampled core.

The torpedo tip may be screwed together with the initial sampling tube, and the tightening of the vertical space is performed by applying a rotational force for further screwing the initial sampling tube and the torpedo tip together. The torpedo tip includes fin structures for preventing the torpedo tip from turning inside the formation while the initial sampling tube is rotated, and the lowering is performed using a translational up and down motion. The compressing causes an upper portion of the sampled core to dissociate from a portion below a compressed zone, and the compressed zone functions as a cap for the upper portion of the sampled core preventing the upper portion from falling out of the sampling tubes. The compressing may be performed by tightening of a vertical space between the initial sampling tube and the torpedo tip and creating an inward bulge in a spacer located within the vertical space. The spacer may be an O-ring. The lowering may be performed by a continuous and controllable force that is pneumatically driven, pulley and winch driven or driven by a combination of both, and the lowering is assisted by vibratory action for penetrating through coarse particulate matter.

Aspects of the present invention provide a method for collecting samples from a formation. The method includes attaching a leading device to a sampling tube, the leading device being susceptible to a translational downward motion into the soils or sediments and being resistant to a rotational motion while within the soils or sediments, driving the sampling tube into the soils or sediments by the translational downward motion, reaching a desired sampling depth, rotating the sampling tube to cause a tightening of a vertical space between the sampling tube and the leading device, and withdrawing the sampling tube and the attached leading device by a translational upward motion. The tightening of the vertical space between the sampling tube and the leading device causes a structural weakness in a sampled core at or near a location of connection between the sampling tube and the attached leading device.

The structural weakness is caused by a compressive force exerted on the sampled core from a deformed object located in the vertical space between the sampling tube and the leading device, and the sampled core above a location of the compressive force is held within the sampling tube by compressed soils or sediments at the location of the compressive force.

Aspects of the present invention provide a system for sampling of a formation. The system includes a frame, a pneumatic driving system installed on the frame, and a sampling assembly coupled to the pneumatic driving system and being driven by the pneumatic driving system. The pneumatic driving system exerts continuous and controllable up and down translational force on the sampling assembly, and the sampling assembly is adapted to being driven down to a depth of 1000 feet in some formations by the up and down translational force.

The pneumatic driving system may be adapted for exerting a force of up to 50,000 lbf. The sampling assembly may includes one or more sampling tubes coupled together to reach a desired sampling depth, and a torpedo tip coupled to a leading sampling tube. The torpedo tip ends in a penetrating nozzle and has a threaded portion adapted for connecting to the leading sampling tube, the torpedo tip having one or more fins along an outer circumference for resisting a rotation of the torpedo once within the formation.

The system may further include a control panel for controlling the pneumatic driving system to move up and down at a selected speed and applying a selected force, an auxiliary vibratory or rotary driving mechanism for driving the sampling assembly through coarse material, and an auxiliary pulley driving system. The auxiliary pulley driving system includes a cable anchored to the frame, a first pulley located above the sampling assembly, a second pulley anchored to the frame, and a winch located after the second pulley and adapted to pull the cable, passing from over the first pulley and under the second pulley, to exert a continuous downward force on the sampling assembly. The winch is operated by an electric, hydraulic, or pneumatic system.

### BRIEF DESCRIPTION OF THE DRAWINGS

FIG. 1 shows a system for retrieving substantially undisturbed soil and sediment samples including a sampling barge or vehicle, according to aspects of the present invention.

FIG. 2 shows a flowchart of a method of sampling soils and sediments, according to aspects of the present invention.

FIG. 3 shows a sampling assembly, according to aspects of the present invention.

FIG. 4 shows a flowchart of a method of retrieving sampled soils and sediments, according to aspects of the present invention.

FIG. 5 shows an exemplary connection between a sampling tube and a torpedo, according to aspects of the present invention.

FIG. 6 shows a further exemplary connection between a sampling tube and a torpedo, according to aspects of the present invention.

FIG. 7 shows various exemplary arrangements of fins around a torpedo, according to aspects of the present invention.

FIG. 8 shows a coring frame, according to aspects of the present invention.

FIG. 9 shows a perspective view of the coring frame of FIG. 8, according to aspects of the present invention.

FIG. 10 shows a pneumatic system for driving the sampling assembly into soils or sediments, according to aspects of the present invention.

FIG. 11 shows a pneumatic system for driving the sampling assembly into soils or sediments together with an electro-mechanical backup system, according to aspects of the present invention.

FIG. 12 shows a side view of the coring frame of FIG. 11, according to aspects of the present invention.

FIG. 13 shows an alternative coring frame for a pneumatic system for driving the sampling assembly into soils or sediments, according to aspects of the present invention.

FIG. 14 shows a flowchart of a method of conducting sampling from soils and sediments, according to aspects of the present invention.

### DETAILED DESCRIPTION OF THE INVENTION

The present invention presents systems, devices and methods for substantially undisturbed sampling of soil and sediments including soft underwater sediments. This invention implements undisturbed sample collection for use in numerous science and engineering fields including environmental science and engineering, civil and geotechnical engineering, hydrogeology, oceanographic sampling, mining explorations, archeology and geology.

In the following written description, soil is generally used to refer to formations on land and sediments are generally used to refer to deposits under a body of water. However, so much of dry land was at one point formed below water. As such, the term formation is used to refer to soils and sediments whether in dry land, saturated soil or vadoze zone. Further, a system built according to the aspects of the present invention may be installed upon and transported on a barge, a truck or any other type of vehicle.

Core sampling disturbs a portion of the streambed during each use. Unimpeded water flow through the corer during descent is important. Otherwise, a hydraulic shock wave (bow wave) is created in front of the orifice that can wash away flocculent or easily resuspended surficial sediments before the corer reaches the sediment surface. Gravity corers, not equipped with a supporting stand, are susceptible to tilt readily on the bottom, which may result in redistribution and resuspension of enclosed sediment and in loss of material. Also, the sampler may penetrate down too deeply to provide a representative sample. The sample can be disturbed during the closing operation and withdrawal from the soil or sediment, and during retrieval. Rotation of a corer during retrieval causes shear stress on the sediment, with ensuing resuspension and redistribution, particularly of soft surficial sediments. Because the rate of entrainment increases with sample area, instruments enclosing a larger area of surface sediments produce disturbance more easily than do corers with narrow tubes. In corers without a secure lid-locking mechanism, resuspension may occur. Resuspension and redistribution of sediment samples obtained by larger corers might also make subsequent sub-sampling complicated.

Aspects of the current invention allow the sampler to penetrate in a controlled manner down to a desired depth in order to collect substantially undisturbed representative samples. While a sample, collected using conventional methods, can be disturbed during the downward motion of the sampler, during the closing operation and withdrawal from the sediment, and during retrieval. The rotation aspect of the current invention allows the corer during retrieval process to cause shear stress on the sediment at the corer interface and cut the sample.

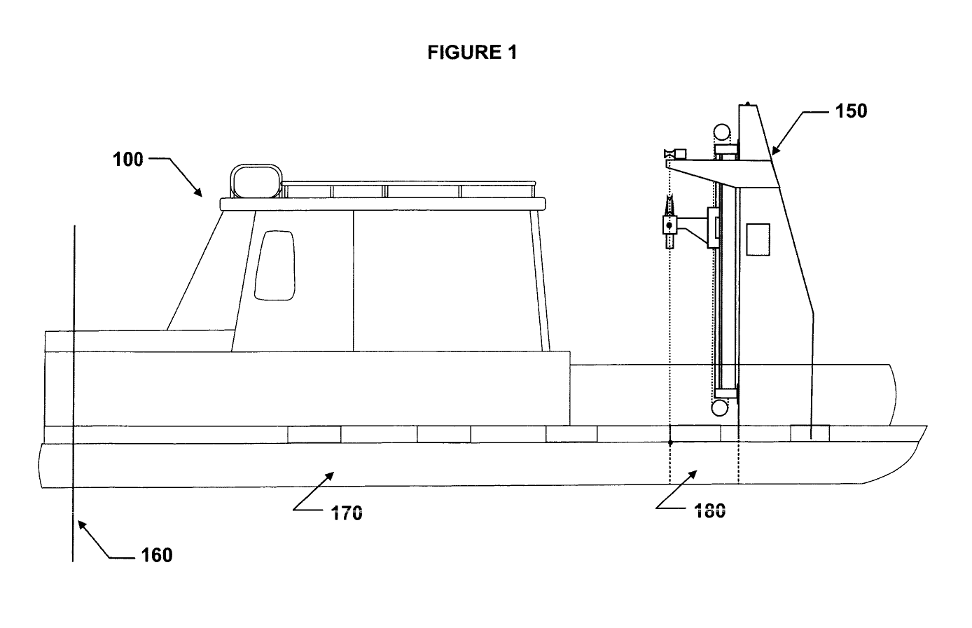

FIG. 1 shows a system for retrieving substantially undisturbed soil and sediment samples including a sampling barge, according to aspects of the present invention.

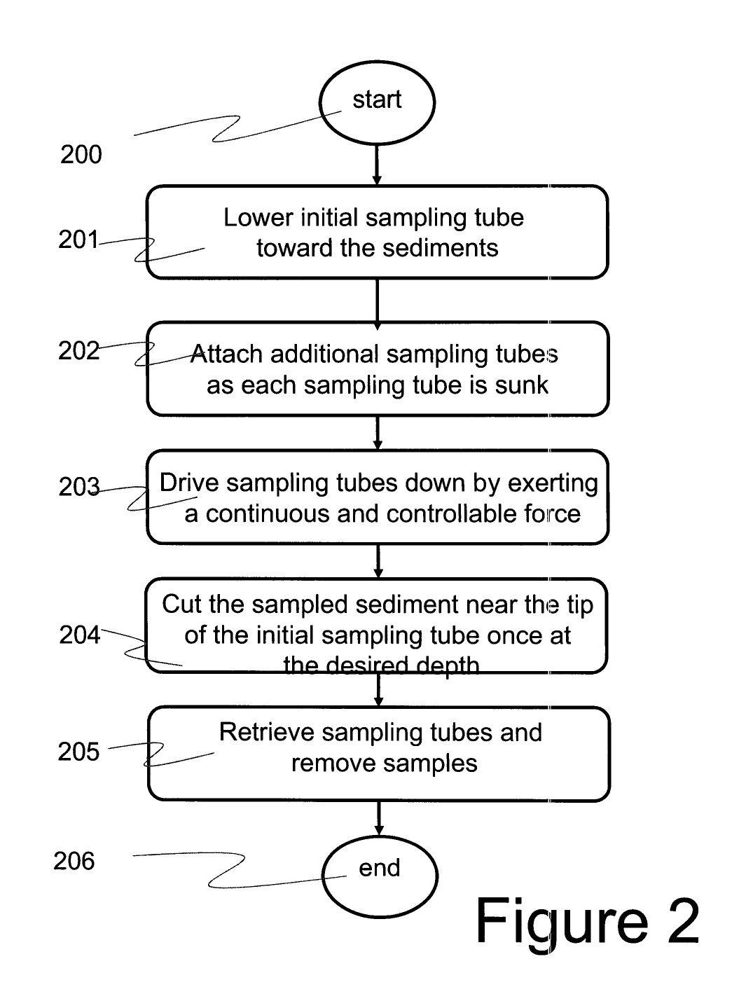

A system for retrieving substantially undisturbed soil or sediment samples includes a sampling boat or barge 100 that is equipped with a coring device 150. Before the start of sampling, the barge is anchored and stabilized by using spuds 160 that are driven into the sediments, by mooring anchors, or by filling a ballast portion 170 of the barge with water, or by a combination of these methods. The base of the barge has an opening 180 through which the coring device may reach the sediment below the barge. The coring device that is aboard the barge is used for collecting sediment samples according to an exemplary method shown in the flowchart of FIG. 2. Stabilizing the barge improves the quality of the sample collection.

While a barge operates on a body of water, the coring device of the aspects of the present invention may be used for soil coring and sampling on land as well. For example, the device may be set up on a truck on another type of vehicle or may be placed directly on land.

FIG. 2 shows a flowchart of a method of sampling soils or sediments, according to the aspects of the present invention.

The method begins at 200. At 201, a core sampling tube is connected to the coring device and lowered into the water through the opening at the bottom of the barge. The lowering of the sampling tube is controlled such that it does not generate a wave that leads to resuspension of sediments below. At 202, additional sampling tubes are screwed, pinned or otherwise secured to a previous sampling tube as each sampling tube is lowered. Four-foot core tubes may be used as the core sampling tube. At 203, after the initial sampling tube has reached the surface of the bottom sediments below, the sampling device exerts a continuous and controllable force to drive the sampling tubes through the sediments. The force is exerted in a straight translational up and down direction. Rotation or pounding of the coring tubes is not necessary. In some aspects of the present invention, the coring device is capable of exerting a variable force ranging between 0 to 60,000 lbf for driving the sampling tubes through the soil and sediments. In one aspect of the present invention, a force of 2500 lbf was tested. The force may be pneumatically generated. At 204, after the initial sampling tube has reached the desired sampling depth, the sample is cut at or near the tip of the sampling tube. At 205, the sampling tubes are retrieved and one by one dismantled and removed as they arrive on the vehicle or barge. At this point, the column of sample collected by each sampling tube may be removed. At 206, the method ends.

While the sampling apparatus vary, typically a sampling tube includes two components of core casing and sampling tube liner. The core casing is usually a steel tube with threading upon which the torpedo is mounted. The sampling tube liner is a clear tube which fits inside the core casing and houses the undisturbed sample. The clear tube allows surface inspection and ensures sample preservation and protection of the sample structural integrity. The term “sampling tube” is used as a general term referring to a combination of both components. Various types of sampling tubes may be used, some of which, do not utilize a liner.

At 203, while the sampling tubes are driven through the soil and sediments by an up and down translational force, the translational force may be complemented with a momentary vibratory motion for getting through obstructions that may be caused by debris or coarse material. The continuous and controllable translational motion may be generated by a pneumatic, electric or hydraulic driver.

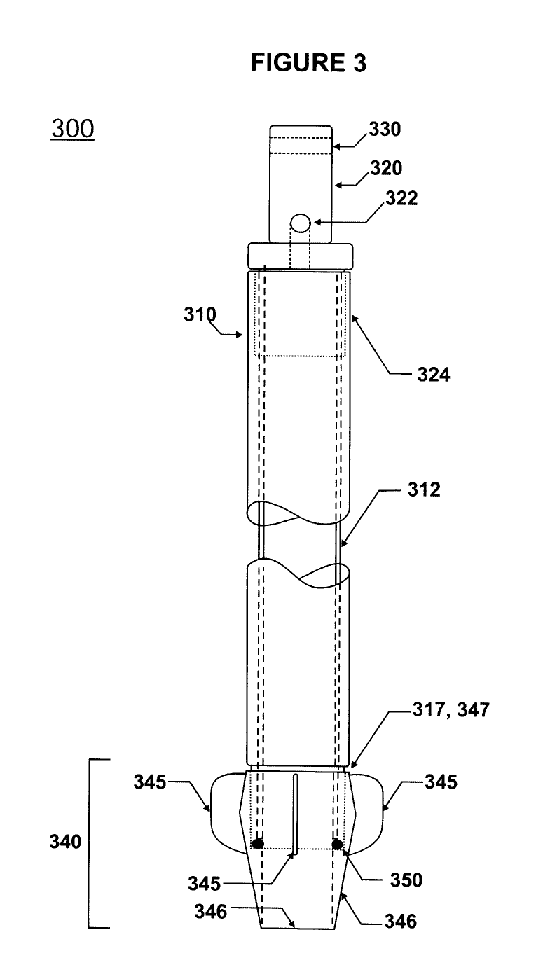

FIG. 3 shows a sampling assembly, according to aspects of the present invention.

Sampling assembly 300 includes the parts that are connected together and penetrate the soil or sediments for sampling. The sampling assembly 300 includes a number of sampling tubes 310 that are connected together and at the leading end connect to a nozzle or a modified torpedo shaped device (torpedo) 340. The successive sampling tubes may be connected together by a variety of mechanisms including screwing of threaded areas, slotted locks, or being pinned together. The leading sampling tube includes a threaded area 317 that screws into a corresponding threaded portion 347 of the torpedo.

The sampling tube 310 encompasses a liner 312 and is held by a core driver plug 320 or is connected to a next sampling tube 310. A locking device 330 locks the core driver plug 320 to the rig or the sampling device. When the sampling tube 310 is connected to the core driver plug 320, instead of being connected to another sampling tube, a vent 322 permits for air and water to exit from the above.

The initial and leading sampling tube 310 is connected to the nozzle 340. In one aspect of the present invention, the nozzle 340 is shaped similar to a torpedo and is called the torpedo 340. The torpedo 340 is threaded inside the upper portion to receive the sampling tube 310. The torpedo 340 ends in a penetrating nozzle 346 at the leading portion. The penetrating nozzle 346 has a sharp and cutting edge that cuts through the soils and sediments as the sampling tubes are pressed down. The diameter of the penetrating nozzle 346 and the liner 312 are substantially equal.

The torpedo 340 includes fins 345 around the circumference of its upper portion. One or more fins may be located around the torpedo. The fins 345 are substantially parallel to the longitudinal axis of the torpedo and the sampling tube to which it is screwed. As such, the fins do not interfere with the descent of the torpedo into the soils or sediments and may indeed accommodate the descent in some types of formations.

Aspects of the present invention place an O-ring 450 inside the torpedo 340 between where the threading 347 ends and the penetrating nozzle 346 begins. O-rings are manufactured in various cross-sections including circular or rectangular cross-sections. Either, type may be used. Initially, when the torpedo 340 is connected to the sampling tube 310, the sampling tube is screwed inside the torpedo such that the O-ring remains substantially flush with the liner 312 and the interior wall of the penetrating nozzle 346. As such, the O-ring does not interfere with the core that is collected inside the sampling tube as the sampling tubes penetrate through the soils or sediments.

An O-ring, also known as a packing, or a toric joint, is a mechanical gasket in the shape of a torus. It is usually a loop of elastomer with a disc-shaped cross-section, designed to be seated in a groove and compressed during assembly between two or more parts, creating a seal at the interface. Aspects of the present invention utilize O-rings made from material of different hardness, including rubber, neoprene, PVC, Teflon, plastic, metal or other material, depending on the hardness of the core that is to be pinched by the bulging action of the O-ring.

Once the desired sampling depth is reached and the sampling tubes are to be retrieved, the sampling tubes are rotated by the coring device to tighten the connection between the sampling tube and the torpedo. The fins 345 of the torpedo 340 hold the torpedo in place and permit such tightening to take place. Without the fins, the torpedo would rotate with all the other sampling tubes to which it is directly connected or indirectly coupled.

As a result of such tightening, the O-ring that was installed to be flush with the internal surface of the liner 312 and the penetrating nozzle 346 tends to bulge inward. The bulging O-ring reduces the internal diameter of the sampling apparatus and pinches the perimeter of the sample at the location of the O-ring. The pinch causes a discontinuity in the soils or sediments inside the sampling assembly 300 and the discontinuity causes the core to break at the location of the discontinuity when the sampling assembly is retrieved. A slight tightening and a slight bulge may be sufficient for achieving the objectives of the sampling. The tightening of the perimeter at the bulging O-ring further keeps the upper part of the core in place by squeezing the core below. The mechanism provided by the torpedo prevents loss of sample which occurs by slide back of sample due to weight of the sample and the vacuum below the core that is created during ascent.

As discussed above, during the retrieval of the sampling tubes, the vacuum created below the sampling assembly may pull down some of the sampled core and result in the loss of the sample as well as loss of information regarding the stratification. Aspects of the present invention prevent or reduce the possibility of sample loss by creating an intentional discontinuity and structural weakness in the core, below which, the core is free to break off and fall out.

Unlike the catcher of the prior art, the pinch does not disturb the core all the way along the sample. Unlike driving the sampling tubes into hard material to create a cap for the core, the pinch does not compress the sampled core.

When sampling in the relatively soft sediments under rivers, lakes, reservoirs, marshes, and ponds, an O-ring made from a rubber material would be sufficient to create an indentation or a cut around the sample core. However, the devices manufactured according to the aspects of the present invention may be utilized for sampling in harder formations if the O-ring that is used is made from a suitably harder material such that the compression of the O-ring is capable of creating a cut in the harder formations. As long as the material of the O-ring is not as resistant as the sampling tube and the torpedo that squeeze the O-ring from two sides, it is the O-ring that will yield and move inward toward the sampled core. Harder O-rings may not be reusable because they may undergo plastic deformation and fail under the pressure. Such O-rings may be replaced for each round of sampling.

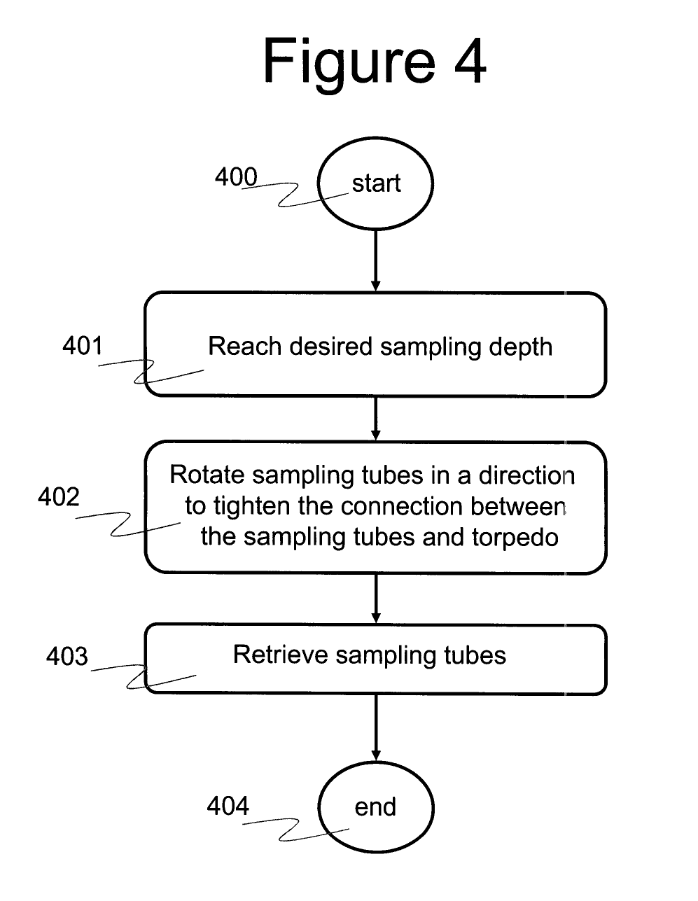

FIG. 4 shows a flowchart of a method of retrieving sampled soils or sediments, according to the aspects of the present invention.

This method begins at 400. At 401, the sampling assembly has reached the desired maximum sampling depth. At 402, the sampling tubes are rotated in a direction to tighten their connection with the torpedo. As explained above, the fins hold the torpedo in place and make the tightening action possible. Without the fins, the entire assembly would rotate together and no tightening would take place. The tightening action creates a bulge in the O-ring that cuts the core ever so slightly and creates a structural weakness in the core at the location of the cut. At 403, the sampling apparatus is retrieved. The slight cut created by the bulging O-ring around the perimeter of the sampled core causes the core to separate from the formation below at or near the location of the cut. As such, the likelihood that the sampled core above the O-ring is retrieved without loss increases significantly. At 404, the method ends.

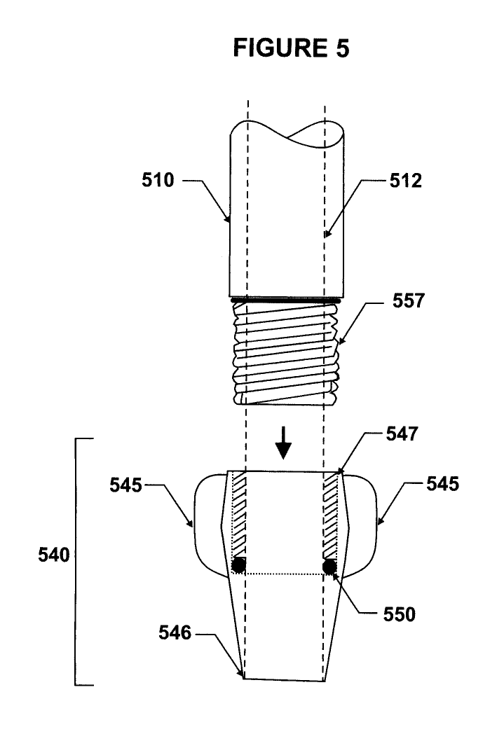

FIG. 5 shows a sampling tube connected to a torpedo, according to aspects of the present invention.

Sampling tube 510 is connected to torpedo 550 at threaded area 557. A liner 512 is located inside the sampling tube 510. The torpedo 550 also includes a threaded portion 547 that screws together with the threaded area 557 of the sampling tube. The torpedo 540 ends in a penetrating nozzle 546. An O-ring 550 is placed at the bottom of the threaded portion 547 of the torpedo, where the threaded area 557 of the sampling tube 510 and the torpedo 540 are screwed together.

When compared to the torpedo 340 of FIG. 3, the torpedo 540 shown in FIG. 5 has fins 545 that extend further down toward the penetrating nozzle 546 portion of the torpedo.

Further, the location of threading 547 that is followed by the location of the O-ring 550 may be adjusted up and down the torpedo. In various aspects of the present invention, the treading and the O-ring may be located further away from the penetrating nozzle 546 and, for example, above the fins.

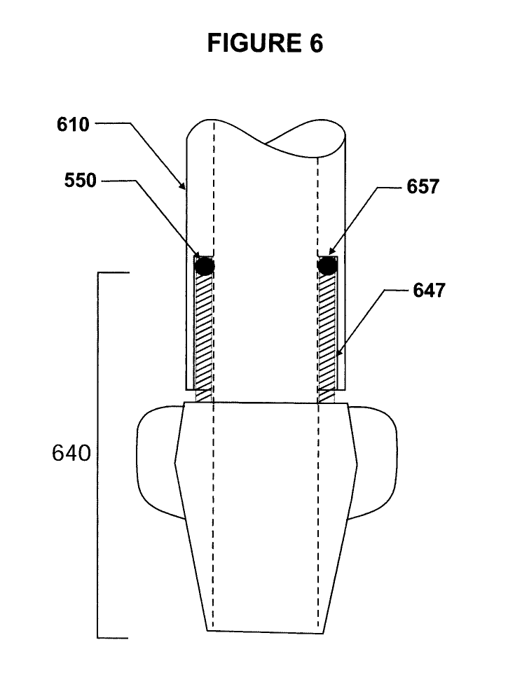

FIG. 6 shows a further exemplary connection between a sampling tube and a torpedo, according to aspects of the present invention.

Various arrangements of the connection between the torpedo and the connecting sampling tube that achieve the same cutting functions fall within the ambit of the current invention.

For example, in FIG. 6, threaded portion 647 of torpedo 640 extends outward above the fins and threading 657 of sampling tube 610 encompasses the threaded portion 647 of the torpedo. Nonetheless, when the sampling assembly penetrates into the soils or sediments and torpedo is held in place by the fins, tightening of the sampling tube 610 around the torpedo 640 causes a bulging of the O-ring 550 and a cutting of the core inside.

The torpedo may be built from various material such as stainless steel. The fins may be stainless steel and may be welded onto the body of the torpedo or may be integrally formed when the torpedo is built in a foundry.

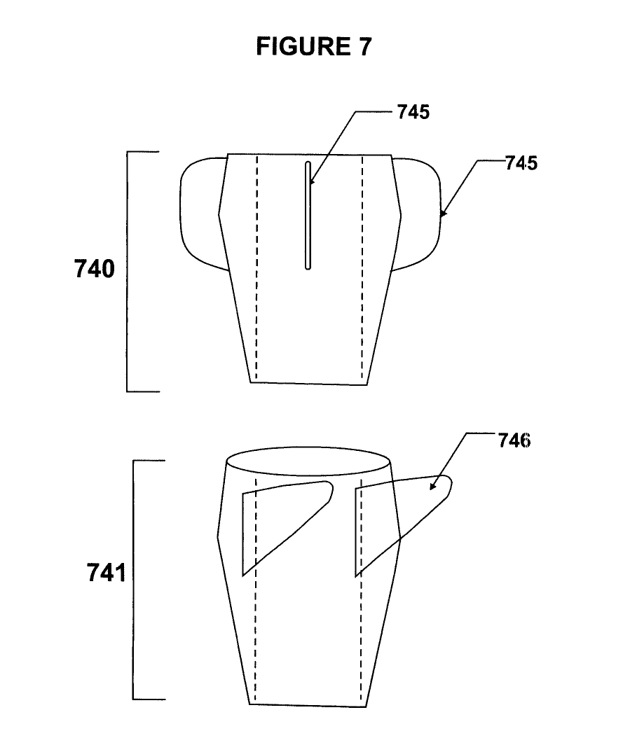

FIG. 7 shows various exemplary arrangements of fins around a torpedo, according to aspects of the present invention.

The fins in FIG. 3, FIG. 5 and FIG. 6 are shown as being perpendicular to the cylindrical body of their respective torpedos. The Perpendicular arrangement is appropriate when the sampling assembly is driven straight down into the soils or sediments. In that case, the perpendicular fins do not interfere with the driving of the sampling assembly down but will resist a rotational motion when in place deep in the soils or sediments. In FIG. 7, torpedo 740 shows fins 745 that protrude perpendicularly from the outer surface of the body of the torpedo. As noted above, the fins may extend partially or completely down the body of the torpedo.

In a different aspect of the present invention, the sampling assembly may be rotated downward into the desired sampling location. For such a driving mechanism, the perpendicular fins present an undesirable resistance to the insertion of the sampling tubes into the soils or sediments that are to be sampled. In FIG. 7, torpedo 741 shows an alternative arrangement of fins 746 that form an angle with the body of the torpedo. The angle between the fins and the torpedo is designed to accommodate the rotational motion of the torpedo downward through the soils or sediments. In such situation, the threading of the sampling tube to the torpedo may be designed to counter the preferable direction of rotation of the fins. Then, an extra rotation of the sampling tube in a reverse direction, without an accompanying pulling motion, would tighten the connection and squeeze the O-ring. In rotary arrangements, a reverse direction of rotation generally extracts the sampling tubes. Therefore, a reverse rotation must be accompanied by force or other mechanism that prevents the pulling out of the tubes.

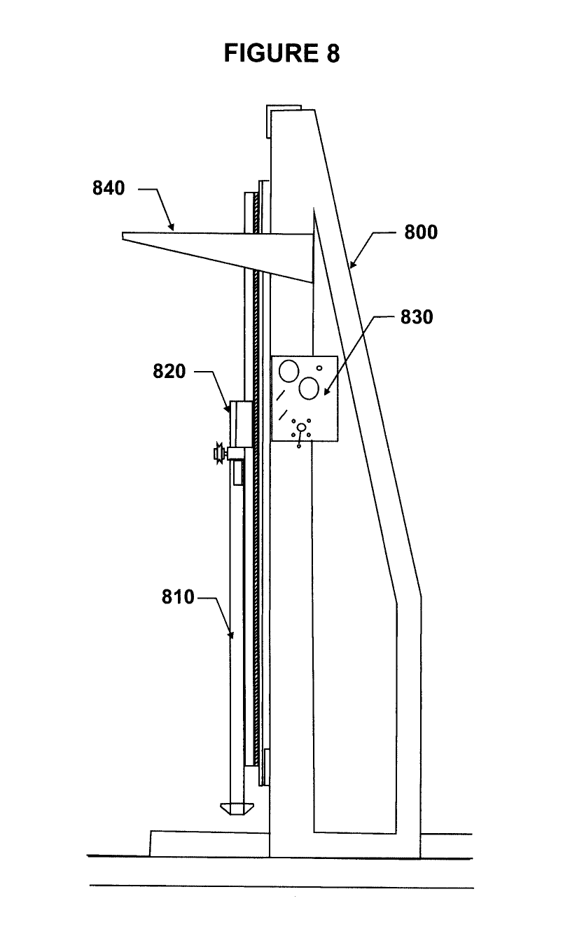

FIG. 8 shows a coring frame, according to aspects of the present invention.

Coring frame 800 is used to provide a frame for sampling assembly 810, which includes sampling tubes, driving mechanism 820, which drives the sampling assembly into and out of the soils or sediments and other formations that are being sampled, and control panel 830 that is used for controlling the driving mechanism 820. A platform 840 may be built as a part of the coring frame and may be used for placing an additional driving mechanism for backup.

In various aspects of the present invention, the sampling assembly may include a torpedo tip or component leading the sampling tubes. In various aspects of the present invention, the driving mechanism 820 may be electromechanical, hydraulic or pneumatic. When a pneumatic driving mechanism is used to create a continuous and finely controllable up and down motion, a rotary or vibratory mechanism may be added to assist driving of the sampling assembly through debris, gravel and coarse material.

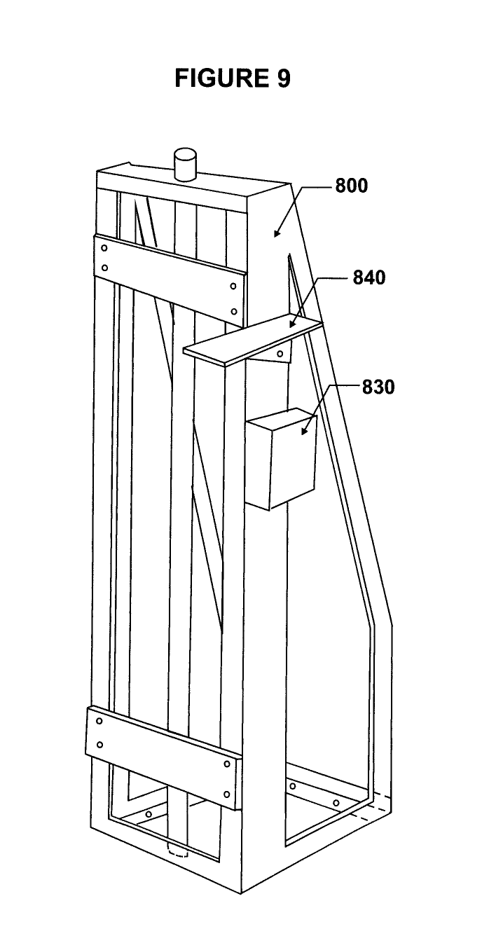

FIG. 9 shows a perspective view of the coring frame of FIG. 8, according to aspects of the present invention.

FIG. 9 shows the coring frame 800 without the sampling assembly 810 and the driving mechanism 820.

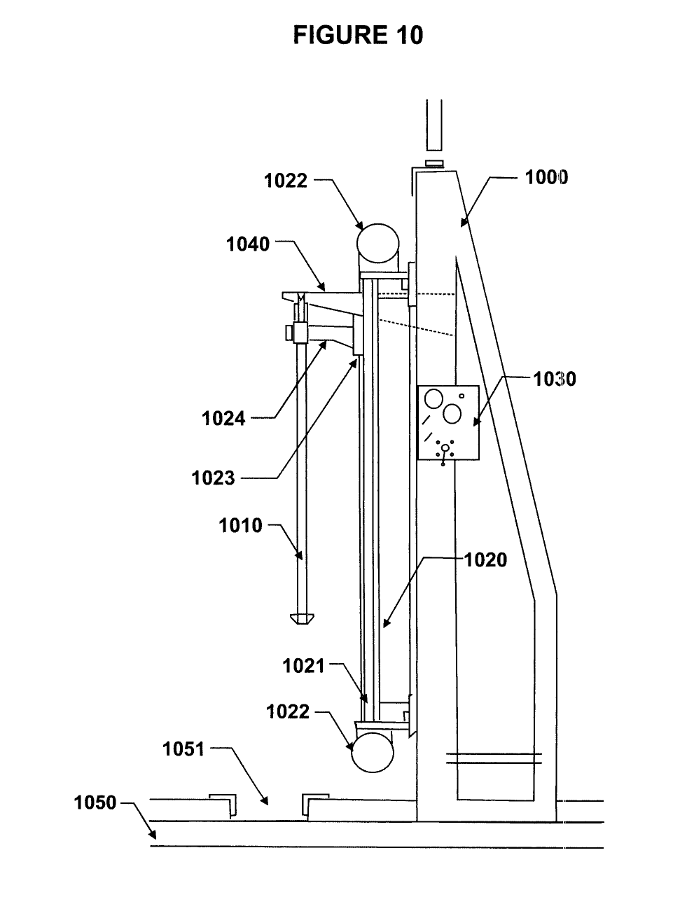

FIG. 10 shows a pneumatic system for driving the sampling assembly into soils or sediments, according to aspects of the present invention.

Coring frame 1000 is used to provide a frame for sampling assembly 1010, driving mechanism 1020, and control panel 1030. A platform 1040 may be used for placing an additional driving mechanism for backup. FIG. 10 further shows a base 1050 of the barge and an opening 1051 in the base of the barge for the sampling assembly 1010 to pass through.

The driving mechanism 1020 is a pneumatic system. In the exemplary aspect shown, the pneumatic driving mechanism 1020 includes a pneumatically driven piston and cylinder system 1021 which are assisted by pulleys 1022. The combination of piston and pulley permits the system to use half the length it would have needed without the pulleys. Pneumatic driving mechanisms that do not utilize a pulley may also be used.

The motion and force of the driving mechanism 1020 may be transferred to the sampling assembly 1010 by various means. In the exemplary aspect shown, a plate 1023 moves with the pneumatic force and a travel pusher bar 1024 transfers the force and the motion of the driving mechanism to the sampling assembly.

The pneumatic driving mechanism pushes the sampling assembly down by a straight translational force instead of vibrating it downward or turning it in a rotary motion. The translational nature of the movement also reduces the disturbance associated with sample removal. The weight of the sampling tubes and the vertical force exerted on the sampling assembly drives the sampling assembly through the soils or sediments. The sharp tip of the torpedo assists in cutting through the soils and sediments. Using the aspects of the present invention, the formation is sliced through instead of being subjected to vibrational disturbance of vibratory coring or the disturbance caused by rotational boring.

Bimba, Inc. of Monee, Ill. provides double wall pneumatic cylinders of limited range that may be applicable for some implementations. The pneumatic driving mechanism may also be implemented, for example, using ICR Basic™ and ICR Plus™ that are products of Tolomatic Inc. of Hamel, Minn. These products have a range of motion, or stroke, of about 24 inches and a thrust of 400 Lbf. A series of rodless, screw driven and belt driven products from Tolomatic provide ranges of up to 24 feet, considering that most sampling tubes are about 4 feet long, with driving forces of up to 2700 lbf. Cylinders with pistons and rods or rodless actuators of Festo, Inc. of Mississauga, Canada, provide other examples of implementation of the pneumatic drive. Finally, cable cylinders of Greenco Inc. of Tampa, Fla., called Cable Trolls™, are shown in FIG. 10 of the drawings as one implementation of the pneumatic drive mechanism to be used with the aspects of the present invention. Devices of Greenco, Inc., provide stroke lengths of up to sixty (60) inches (approximately 13 feet) and forces of up to nearly 2500 Lbf. In harder formations and for larger sampling depths, using several of such pneumatic devices together can exert a force of required magnitude.

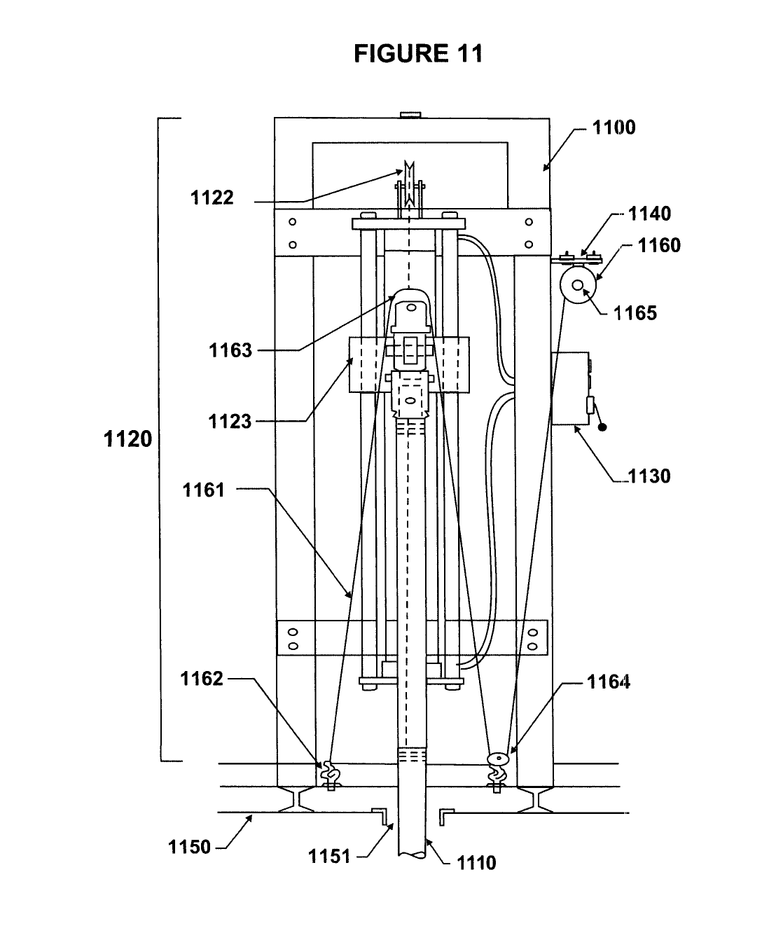

FIG. 11 shows a pneumatic system for driving the sampling assembly into soils or sediments together with an electro-mechanical backup system, according to aspects of the present invention.

Coring frame 1100 is used to provide a frame for sampling assembly 1110, driving mechanism 1120, and control panel 1130. A plate 1123 transfers the force of the driving mechanism 1120 to the sampling assembly 1110. Deck or base 1150 of the barge has an opening 1151 for the sampling assembly 1110 to pass through. Platform 1140 is used for placing an additional electromechanical driving mechanism 1160 for backup.

The auxiliary electromechanical driving mechanism 1160 is shown to include cables and pulleys that are operated by a winch or another type of motor. A winch is a mechanical device that is used to pull in (wind up) or let out (wind out) or otherwise adjust the “tension” of a cable. The exemplary auxiliary driving mechanism 1160 includes a cable 1161 that is anchored at a hook 1162 to the deck 1150 of the barge or to the frame 1100. The cable 1161 passes over a first pulley 1163 at the top of the sampling assembly 1110 and passes underneath a second pulley 1164 that is also anchored to the base 1150 of the barge or to the frame 1100. The cable 1161 then moves back up to connect to a winch 1165 that pulls the cable and winds it around the winch. The winch 1165 is shown to be located on the platform 1140. However, the location of the winch and the arrangement of the cable and the pulleys may be adjusted and modified according to the space available on the barge.

As the winch 1165 pulls the cable 1161, the first pulley 1163 is pushed down in a continuous motion. The movement of the first pulley 1163, and therefore the force exerted by this pulley on the sampling assembly 1110, is as continuous and as controllable as the winch 1165 that is used for applying the force. The push force of the first pulley 1163 on the sampling assembly 1110 may be used independently from the pneumatic driving mechanism 1120 or in assistance to this mechanism for driving the sampling assembly.

If the locations of various parts of the arrangement are reversed, then the first pulley could be used to push the sampling assembly out of the soils or sediments. For this reversal, the hinge 1162 and the second pulley 1164 are moved up and anchored to the top of the frame 1100, such that they can pull the first pulley 1163 upward. The first pulley would be connected to the sampling tubes such that it can pull a sampling tube upward.

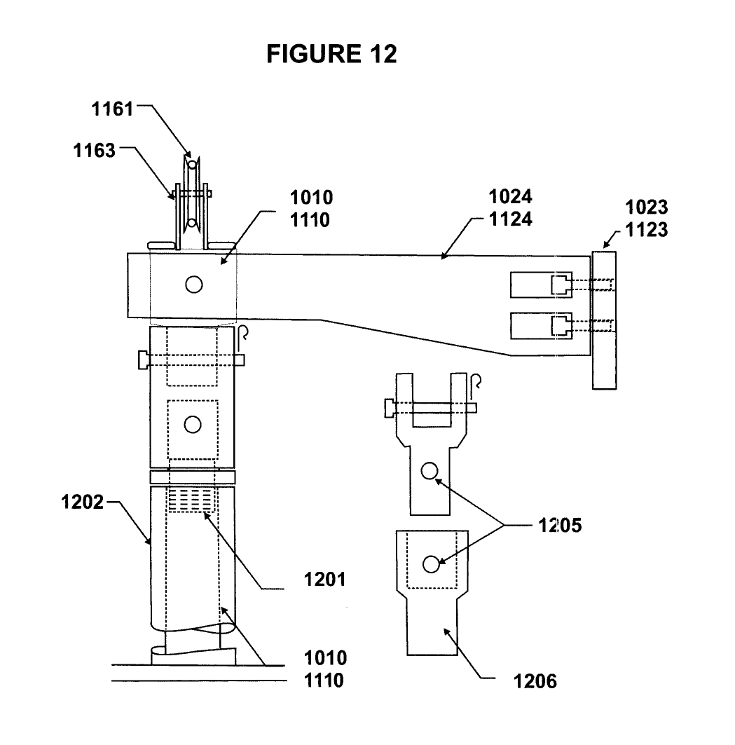

FIG. 12 shows a side view of the coring frame of FIG. 11, according to aspects of the present invention.

FIG. 12 also shows some of the aspects of FIG. 10 in more detail. Plate 1023, 1123 connects to the driving mechanism 1020, 1120 of FIG. 10 and FIG. 11, respectively. A travel pusher bar 1024, 1123 is connected to the plate 1023, 1123 at one end and to the sampling assembly 1010, 1110 at the other end. As the plate travels up and down, so does the travel pusher bar.

FIG. 12 also shows one exemplary mechanism of connecting the travel pusher bar to the plate.

Further, the first pulley 1163 of the backup or auxiliary driving mechanism 1160 and the cross section of the cable 1161 passing over the first pulley 1163 are shown in this drawing.

The drawing also shows a threaded screw 1201 mechanism for coupling the sampling tubes 1202 together and pin 1205 mechanism for connecting a Kelly bar 1206 at the end of the sampling tubes for the length of the sampling assembly that is merely extending through water and does not reach the sediments to be sampled.

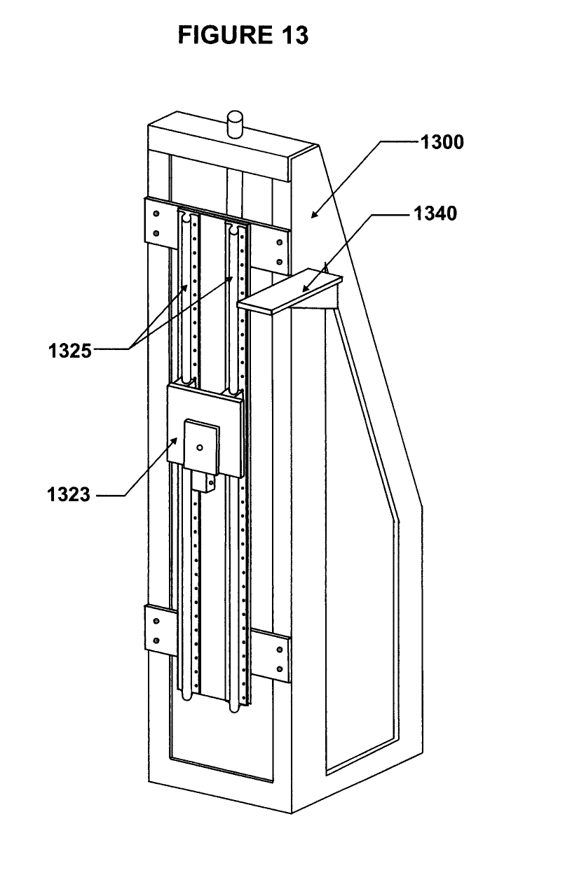

FIG. 13 shows an alternative coring frame for a pneumatic system for driving the sampling assembly into soils or sediments, according to aspects of the present invention.

Coring frame 1300 includes an optional platform 1340 as shown in some of the previous examples of the coring frames. In FIG. 13, tracks 1325, along which plate 1323 travels, are also shown. The plate 1323 is similar to the plate 1023 in FIG. 10 and the plate 1123 in FIG. 12 in that it is used to transfer the force and motion of the primary driving mechanism to the sampling assembly. In FIG. 11 and FIG. 12, similar plates 1023 and 1123 are connected to the sampling assembly via the travel pusher bar 1024 or 1124 respectively. Use of the tracks 1325 stabilizes the transfer of the translational movement of the primary driving mechanism to the sampling assembly.

The tracks 1325 may be implemented, for example, using linear ball splines by IKO Nippon Thompson, Co., Ltd., of Tokyo, Japan or the products by NB Linear Systems of Hanover Park, Ill.

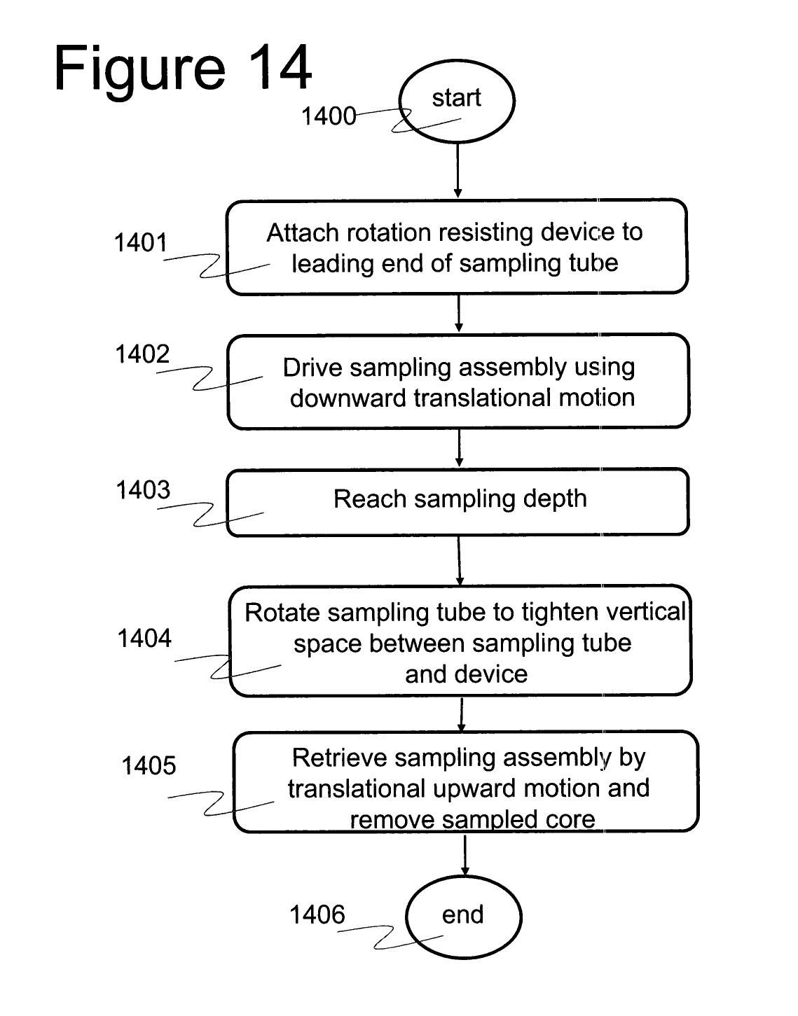

FIG. 14 shows a flowchart of a method of conducting sampling from soils or sediments, according to aspects of the present invention.

The method begins at 1400. At 1401 a rotation resistant leading component or device is attached to a sampling tube to form a sampling assembly. The leading component or device is susceptible to a translational downward motion into the soils or sediments but, once within the formation, it resists a rotational motion. At 1402, the sampling assembly is driven into the sediments using a downward translational motion which may result from a translational downward force. At 1403, the desired sampling depth is reached by the sampling assembly. At 1404, the sampling device is rotated to tighten a vertical space between the rotation-resistant component and the sampling tube. This tightening of the vertical space impacts the sampled cored within the sampling tube and the device at the location of the connection between the device and the sampling tube. At 1405, the sampling assembly is retrieved by a translational upward motion and the sampled core is removed. The device is not resistant to upward motion and is readily retrieved. At 1406, the method ends.

The tightening of the vertical space between the sampling tube and the leading device causes a structural weakness in the sampled core at or near a location of connection between the sampling tube and the attached leading device. The structural weakness increases the likelihood that the core would break at the location of the weakness when the sampling assembly is being retrieved.

The structural weakness may be caused by a compressive force exerted on the sampled core from a deformed object located in the vertical space between the sampling tube and the leading device. The structural weakness may be cause by release of some non-contaminating chemical that is known to dissolve the particular formation being sampled. Equivalent mechanisms triggered by the tightening of the vertical space are also possible.

When a compressive force is exerted on the core as a result of the tightening, the sampled core above a location of the compressive force is held within the sampling tube by compressed soils or sediments at the location of the compressive force. The compressed soils or sediments behave like a cap, capping the sampled core from below.

The contrast between the impact of the translational motion and the rotational motion on the device triggers a mechanism at the device that impacts the sampled cored. In the above examples the mechanism was the elastic or plastic deformation of an O-ring that would compress the core. The tightening of the space may instead, for example, trigger a blade that cuts the core clean and closes the bottom of the sampling tube shut.

The two motions may be used in reverse and the mechanism would still remain effective. If the device attached to the sampling tube is susceptible to a rotary motion, but once subjected to a tug or a push, it triggers a mechanism that impacts the core, the same effect is obtained: the core is cut and may even be capped. However, the translational motion used by the exemplary aspects described above tends to be less disturbing to the environment being sampled when compared to a rotary or vibratory motion.

Moreover, the tightening of the vertical space that triggered the deformation of the O-ring in the exemplary aspects described above, may be replaced by a widening of the vertical space that would release an otherwise contained mechanism for severing the core and containing it. For example, if the sampling tube is rotated to loosen the connection with the torpedo and the vertical space is increased, a spring compressed in this space may be released and cut and cap the core.

An ideal sediment sampler has the following characteristics:

allows free flow-through of water during descent, to avoid generating a shock wave,

is equipped with a straight-angle cutting edge, smooth interior surface and thin walls to disturb the sediments as little as possible,

is hermetically sealed during ascent,

allows sub-sampling,

is weight adjustable to penetrate various substrates,

has a sufficient collection volume to meet analysis requirements,

takes sediment samples efficiently and consistently in different depths of water,

takes sediment samples efficiently and consistently at the sampling depths desired,

does not contaminate or alter the nature of sediments,

requires as little additional equipment as possible,

is easy to use and reliable and does not require extensive training for personnel, and

is easily transported and set up on site.

Further, the dimensions of the cutting head, body of corer and core tube are among the key factors to be taken into account to ensure high-quality samples. The parameters to be considered include: cutting angle, diameter of corer, surface ratio (volume displaced by corer in relation to volume sampled), internal friction ratio, external friction ratio, and length of core tube.

Aspects of the present invention provide devices, systems and methods that satisfy many of the above characteristics and take into account many of the above factors.

The present invention has been described in relation to particular examples, which are intended to be illustrative rather than restrictive, with the scope and spirit of the invention being indicated by the following claims and their equivalents.

1. A device for sampling soils or sediments, the device comprising:
a cylinder having a threaded portion toward one end and leading to a penetrating nozzle toward an opposite end; and
one or more fins located around and protruding outward from an external surface of the cylinder in a manner not to interfere with a downward movement of the cylinder through the soils or sediments,
wherein the threaded portion is adapted to be connected to a sampling tube, and
wherein the cylinder is adapted for receiving an O-ring, the O-ring situated to receive a compressive force responsive to a tightening of the threaded portion to the sampling tube.

2. The device of claim 1, wherein the fins are formed selecting from: protruding perpendicularly outward from the external surface of the cylinder or forming an angle different from 90 degrees with the external surface of the cylinder.

3. The device of claim 1, wherein the fins are formed selecting from: extending along all of a length of the cylinder or extending partially along the cylinder.

4. The device of claim 1, wherein the O-ring is received inside the cylinder below the threaded portion.

5. The device of claim 1, wherein the O-ring is received above the threaded portion away from the penetrating nozzle.

6. The device of claim 1, wherein the device is made from stainless steel.

7. The device of claim 1, wherein the fins are either welded onto the cylinder or cast manufactured integrally with the cylinder.

8. A system for collecting samples from a formation, the system comprising:
one or more sampling tubes adapted to be connected together lengthwise;
a torpedo ending in a penetrating nozzle and having a threaded portion adapted for connecting to a sampling tube from among the sampling tubes, the torpedo having one or more fins along an outer circumference located not to interfere with penetration of the torpedo in the formation but resisting a rotation of the torpedo once within the formation;
an O-ring located between the torpedo and the sampling tube and adapted to bulge inward toward a center of the torpedo responsive to a tightening of the torpedo to the sampling tube; and
a driving mechanism for driving and retrieving the sampling tubes and the torpedo into and from the formation.

9. The system of claim 8,
wherein the driving mechanism drives the sampling tubes by an up and down translational motion,
wherein the fins protrude perpendicularly from an outer surface of the torpedo, and
wherein the torpedo is tightened to the sampling tube by a rotational motion of the sampling tube.

10. The system of claim 8, wherein the driving mechanism is selected from pneumatic, pulley and winch or a combination of the two.

11. The system of claim 10, further comprising:
a frame for holding the driving mechanism; and
a vehicle for holding the frame and transporting the frame to a sampling location,
wherein the vehicle is substantially stabilized by filling a ballast with water or by sinking spuds into the soils or sediments, or by a combination of both, when the vehicle is a barge.

12. A method for collecting cores from a formation, the method comprising:
lowering an initial sampling tube within the formation, the initial sampling tube being led by a torpedo tip connected to the initial sampling tube;
attaching additional sampling tubes as required to reach a desired sampling depth;
compressing sampled core, inside the initial sampling tube, near an interface between the initial sampling tube and the torpedo tip, once at the desired sampling depth; and
retrieving the sampling tubes and collecting the sampled core after the compressing of the sampled core.

13. The method of claim 12,
wherein the torpedo tip is screwed together with the initial sampling tube,
wherein the tightening of the vertical space is performed by applying a rotational force for further screwing the initial sampling tube and the torpedo tip together,
wherein the torpedo tip includes fin structures for preventing the torpedo tip from turning inside the formation while the initial sampling tube is rotated, and
wherein the lowering is performed using a translational up and down motion.

14. The method of claim 12,
wherein the compressing causes an upper portion of the sampled core to dissociate from a portion below a compressed zone, and
wherein the compressed zone functions as a cap for the upper portion of the sampled core preventing the upper portion from falling out of the sampling tubes.

15. The method of claim 12, wherein the compressing is performed by tightening of a vertical space between the initial sampling tube and the torpedo tip and creating an inward bulge in a spacer located within the vertical space.

16. The method of claim 15, wherein the spacer is an O-ring.

17. The method of claim 15,
wherein the lowering is performed by a continuous and controllable force that is pneumatically driven, pulley and winch driven or driven by a combination of both, and
wherein the lowering is assisted by vibratory action for penetrating through coarse particulate matter.

18. A method for collecting samples from a formation, the method comprising:
attaching a leading device to a sampling tube, the leading device being susceptible to a translational downward motion into the soils or sediments and being resistant to a rotational motion while within the soils or sediments;
driving the sampling tube into the soils or sediments by the translational downward motion;
reaching a desired sampling depth;
rotating the sampling tube to cause a tightening of a vertical space between the sampling tube and the leading device; and
withdrawing the sampling tube and the attached leading device by a translational upward motion.

19. The method of claim 18,
wherein the tightening of the vertical space between the sampling tube and the leading device causes a structural weakness in a sampled core at or near a location of connection between the sampling tube and the attached leading device,
wherein the structural weakness is caused by a compressive force exerted on the sampled core from a deformed object located in the vertical space between the sampling tube and the leading device, and
wherein the sampled core above a location of the compressive force is held within the sampling tube by compressed soils or sediments at the location of the compressive force.

20. A system for sampling of a formation, the system comprising:
a frame;
a pneumatic driving system installed on the frame; and
a sampling assembly coupled to the pneumatic driving system and being driven by the pneumatic driving system,
wherein the pneumatic driving system exerts continuous and controllable up and down translational force on the sampling assembly, and
wherein the sampling assembly is adapted to being driven down to a depth of 1000 feet in some formations by the up and down translational force.

21. The system of claim 20, wherein the pneumatic driving system is adapted for exerting a force of up to 50,000 lbf.

22. The system of claim 20, wherein the sampling assembly includes:
one or more sampling tubes coupled together to reach a desired sampling depth; and
a torpedo tip coupled to a leading sampling tube,
wherein the torpedo tip ends in a penetrating nozzle and has a threaded portion adapted for connecting to the leading sampling tube, the torpedo tip having one or more fins along an outer circumference for resisting a rotation of the torpedo once within the formation.

23. The system of claim 20, further comprising:
a control panel for controlling the pneumatic driving system to move up and down at a selected speed and applying a selected force;
an auxiliary vibratory or rotary driving mechanism for driving the sampling assembly through coarse material; and
an auxiliary pulley driving system,
wherein the auxiliary pulley driving system includes:
a cable anchored to the frame;
a first pulley located above the sampling assembly;
a second pulley anchored to the frame; and
a winch located after the second pulley and adapted to pull the cable, passing from over the first pulley and under the second pulley, to exert a continuous downward force on the sampling assembly, and
wherein the winch is operated by an electric, hydraulic, or pneumatic system.
